(19) United States
(12) Patent Application Publication
(10) Pub. No.: US 2021/0282597 A1
(43) Pub. Date: Sep. 16, 2021

(54) FOOD MIXER SCRAPER AND METHOD OF OPERATION

(71) Applicant: King-Yuan Lin, Dallas, TX (US)

(72) Inventor: King-Yuan Lin, Dallas, TX (US)

(21) Appl. No.: 16/817,316

(22) Filed: Mar. 12, 2020

(51) Int. Cl. A47J 43/07; A47J 43/044; A47J 43/10; B01F 7/00; B01F 7/32

(52) U.S. Cl. CPC A47J 43/0711; A47J 43/044; A47J 43/1093; B01F 2215/0014; B01F 7/00583; B01F 7/32; A47J 2043/04481; B01F 7/00208

(57) ABSTRACT

A stand mixer is provided, which includes a mixing bowl and one or more beaters configured to rotate within the bowl and orbit about a common axis that is concentric with the bowl. The mixer further includes a scraper with an edge that is shaped to conform to an inside wall of the bowl, and which is also configured to orbit, with the beaters, about the common axis, while rotating at the same rate so that the edge of the scraper remains in contact with the inner wall of the bowl.

### RELATED CASES

This application claims the benefit of Provisional Patent Application Ser. No. 62/792,331, filed Jan. 14, 2019, which application is incorporated herein by reference in its entirety.

### BACKGROUND

### Technical Field

The present disclosure relates generally to stand mixers, and in particular with self-scraping mixers.

### Description of the Related Art

A stand mixer is a device used in many home and commercial kitchens to mix ingredients for cooking, baking, etc. The mixer has a base, with a cradle configured to securely hold a mixing bowl. A vertical post is coupled to the base and supports an arm that is cantilevered over the bowl, with one or more motor-driven mixing elements extending from the arm down into the bowl, with the motor typically housed in the arm. The bowl can be motor-driven to rotate as the mixing element(s) rotate in place, or the mixing elements can be configured to operate in a planetary motion, in which the elements rotate about respective axes, while the axes rotate about a central axis, etc. The mixing elements are often interchangeable, with different kinds of elements used for different mixing tasks, and/or for light, medium, or heavy duty. Examples of different mixing elements include wire whip, whisk, flat beater, dough hook, etc.

### BRIEF SUMMARY

According to an embodiment, a stand mixer is provided, which includes a mixing bowl and one or more beaters configured to rotate within the bowl and orbit about a common axis that is concentric with the bowl. The mixer further includes a scraper with an edge that is shaped to conform to an inside wall of the bowl, and which is also configured to orbit, with the beaters, about the common axis, while rotating at the same rate so that the edge of the scraper remains in contact with the inner wall of the bowl.

According to an embodiment, a stand mixer is provided, including a bowl cradle configured to hold a circular mixing bowl, and a drive mechanism. The drive mechanism includes a first socket and a second socket, and is configured to rotate the first socket and to orbit the first and second sockets relative to a bowl held by the bowl cradle. The drive mechanism is further configured to hold the second socket such that the second socket rotates synchronously.

According to an embodiment, a method for operating a stand mixer is provided. The method includes coupling a beater to a drive mechanism of the stand mixer, coupling a scraper to the drive mechanism, engaging a mixing bowl to a cradle of the stand mixer, and mixing the contents of the mixing bowl. This is accomplished by rotating the beater while orbiting the beater relative to a central axis of the mixing bowl. The method further includes scraping the side of the mixing bowl by orbiting the scraper relative to the central axis of the mixing bowl while synchronously rotating the scraper.

### BRIEF DESCRIPTION OF THE DRAWINGS

FIGS. 1 and 2 are perspective views of a stand mixer, according to an embodiment, in which the stand mixer is shown, in FIG. 1, configured for operation, and, in FIG. 2, in a standby configuration.

FIG. 3 is a perspective view of a stand mixer, according to an embodiment, with a portion of the mixing bowl cut away to show details of the bowl scraper.

FIG. 4 is a diagrammatic plan view of a drive mechanism, according to an embodiment, of a stand mixer such as the stand mixer described with reference to FIGS. 1-2.

FIG. 5 is a perspective view of a stand mixer, according to an embodiment, that includes a pair of scrapers positioned to clean opposite sides of the mixing bowl as they orbit about the center of the bowl.

FIG. 6 is a top perspective view of a bowl and a pair of scrapers of a stand mixer, according to an embodiment.

FIG. 7 is a perspective view of a stand mixer, according to an embodiment, that is configured for large batch mixing, such as might be used in commercial or industrial applications.

FIGS. 8A and 8B are perspective views of a stand mixer 190, according to another embodiment, that is configured for commercial or industrial applications.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

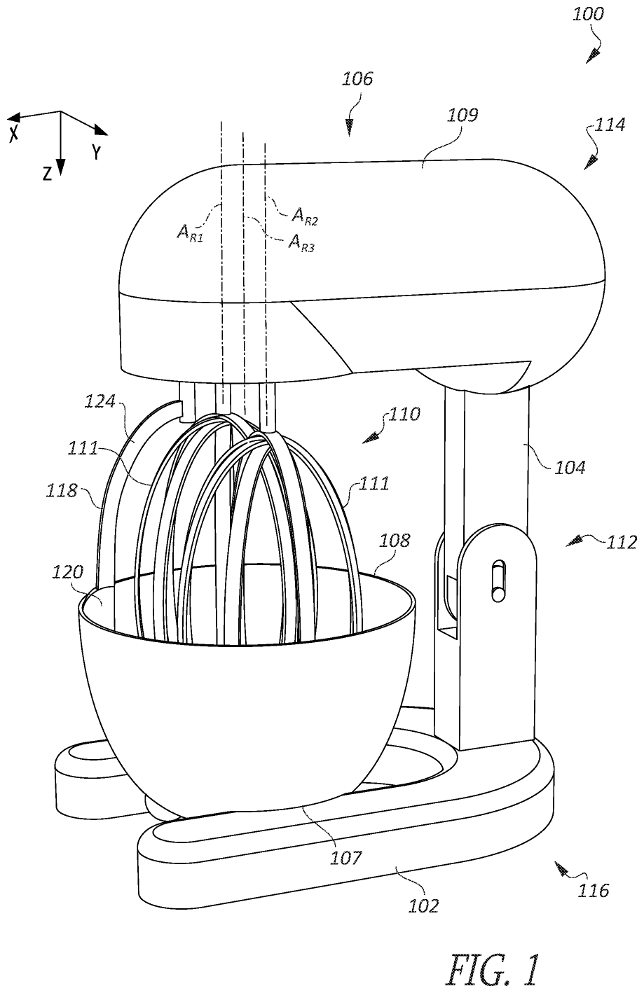

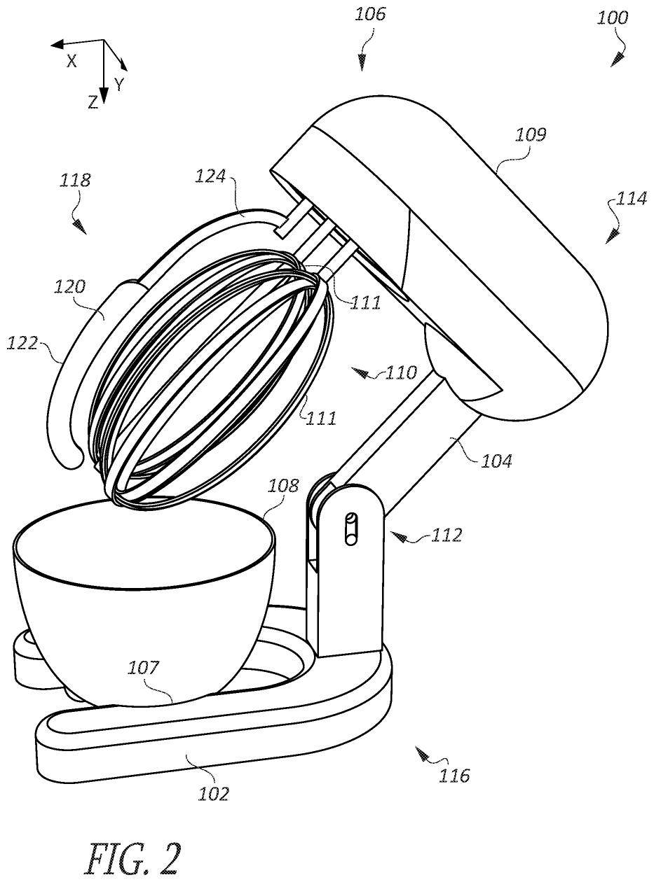

FIGS. 1 and 2 are perspective views of a stand mixer 100, according to an embodiment, in which the stand mixer is shown, in FIG. 1, configured for operation, and, in FIG. 2, in a standby configuration. The stand mixer 100 includes a base 102, a vertical post 104, a cantilevered arm 106, and a cradle 107 configured to receive a mixing bowl 108. The cantilevered arm 106 includes a housing 109 that contains a motor and drive mechanism. A mixing element 110 extends from the arm 106 into the bowl 108—in the example of FIGS. 1 and 2, the mixing element 110 includes two mixing components 111, which, in the illustrated example, are a pair of beaters. The vertical post 104 has a hinge mechanism 112 around which an upper assembly 114, including an upper portion of the vertical post 104 and the cantilevered arm 106, rotates, relative to a lower assembly 116, which includes the base 102 and a lower portion of the post, between an operating position, as shown in FIG. 1, and a standby position, as shown in FIG. 2. The bowl 108 is held securely in the cradle arrangement 107 of the base 102 to prevent movement of the bowl during operation of the mixer 100. The stand mixer 100 also includes a bowl scraper 118 positioned and configured to scrape the side of the bowl 108 during operation. According to an embodiment, the bowl scraper 118 includes a blade 120 with a scraping edge 122, and a handle 124 configured to couple to the drive mechanism of the mixer 100, as will be described in some detail below.

As used hereafter and in the claims, the term beater refers broadly to any type of mixing element component, including, for example, whisks, flat beaters, dough hooks, etc., except where the term is otherwise explicitly defined.

In FIG. 1, the mixer 100 is shown with the upper assembly 114 in the operating position, in which the mixing element 110 and the bowl scraper 118 positioned in the mixing bowl 108. In FIG. 2, which shows the stand mixer 100 in the standby configuration, the upper assembly 114 is rotated back into the standby position, in which the mixing element 110 and the bowl scraper 118 are lifted out of the mixing bowl 108, giving an operator access to the bowl, its contents, the mixing element, and the scraper. During operation of the stand mixer 100, with the upper assembly 114 in the operating position shown in FIG. 1, beaters of the mixing element 110 are configured to rotate, respectively, about first and second axes of rotation A_{R1}, A_{R2} that lie parallel to a Z-axis, in the drawing. According to an embodiment, where the mixing element 110 includes two beaters 111, such as those shown in FIGS. 1 and 2, they are configured to counter rotate, so that they mesh together during rotation for effective mixing of the contents of the mixing bowl 108. Meanwhile, the entire mixing element 110 is configured to orbit about a third, or central axis of rotation A_{R3} that is concentric with the position of the mixing bowl 108. The pair of beaters are shaped to substantially conform to the shape of the mixing bowl 108 so as to automatically incorporate a majority of the contents of the bowl during operation, although other types of beaters 111, such as, e.g., dough hooks, may not be shaped to conform exactly to the bowl shape.

The bowl scraper 118 is also configured to orbit with the mixing element 110 about the second axis of rotation A_{R3}. However, in contrast to the beaters 111 of the mixing element 110, the scraper does not also rotate about another axis, but is fixed, so as to continually present a same, or fixed aspect, relative to the central axis of rotation A_{R3}. The shape of the scraper 118 is selected so as to remain in contact with an inner surface of the mixing bowl 108. Accordingly, as the mixing element 110 orbits within the bowl 108, mixing the contents, the scraper 118 also orbits within the bowl, cleaning the side of the bowl and moving material from the side of the bowl toward the center.

According to an embodiment, the blade 120 of the bowl scraper 118 is made of nylon, and is substantially rigid, which enables the scraper to move even heavy masses of batter or dough without significantly deforming. According to another embodiment, the blade 120 is made of an elastomeric material, such as, e.g., urethane, silicone, synthetic or natural rubber, etc., and is configured to be positioned so as to flex slightly against the wall of the mixing bowl 108 and provide a seal against the bowl to effectively clean the bowl as it passes. According to a further embodiment, the blade 120 includes a reinforced or stiffened body so as to resist deformation, with a scraping edge 122 that is of an elastomeric material configured to flex slightly against the wall of the mixing bowl 108.

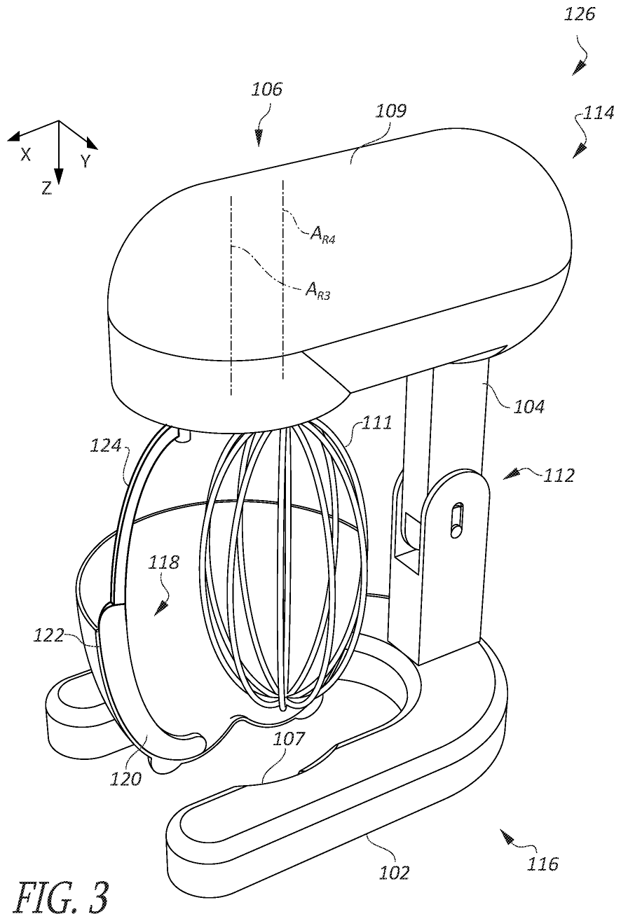

FIG. 3 is a perspective view of a stand mixer 126, according to an embodiment, with a portion of the mixing bowl 108 cut away to show details of the bowl scraper 118. The stand mixer 126 is similar in most respects to the stand mixer 100 described above with reference to FIGS. 1-2. However, the mixing element 110 of the stand mixer 126 of FIG. 3 includes a single beater 111 configured to rotate about a fourth axis of rotation A_{R4}, while rotating with the scraper 118 about the central axis of rotation A_{R3}. According to an embodiment, the scraper 118 and the beater 111 are coupled to the drive mechanism so as to remain on opposite sides of the bowl 108 during operation.

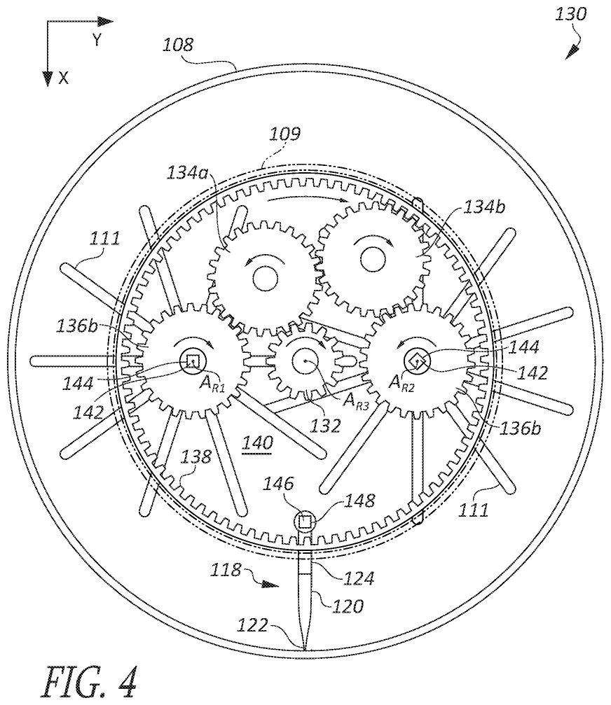

FIG. 4 is a diagrammatic plan view of a portion of a stand mixer 100, such as the stand mixer described with reference to FIGS. 1-2, according to an embodiment, showing details of a drive mechanism 130 of the mixer. The housing 109 of the stand mixer 100 is largely omitted, in order to show the drive mechanism 130, although walls of the housing adjacent to the mechanism are represented in phantom lines. The drive mechanism 130 is positioned within the housing 109 over the location of the mixing bowl 108. A motor is positioned elsewhere in the housing, and is coupled, via appropriate reduction and transmission gears and shafts to a drive gear 132. The drive gear 132 meshes with a first transmission gear 134a, which in turn meshes with a second transmission gear 134b, which is the same size as the first transmission gear. First and second output gears 136a, 136b are driven by the first and second transmission gears 134a, 134b, respectively. In this arrangement, the first output gear 136a is separated from the drive gear 132 by the first transmission gear 134a alone, while the second output gear 136b is separated from the drive gear 132 by both the first and the second transmission gears 134a, 134b. As a result, the first and second output gears 136a, 136b, rotate in opposite directions, enabling the beaters 111 to mesh as they rotate. The second transmission gear 134b also meshes with a ring gear 138, to which a drive plate 140 is coupled so as to rotate therewith. In the embodiment shown, the drive plate is circular, with the ring gear 138 coupled concentrically thereto. The drive plate 140 and/or the ring gear 138 are rotatably coupled to the housing 109 of the stand mixer 100. In FIG. 4, the drive plate 140 is rendered transparent, to show the positions of the beaters 111 and the scraper 118.

The drive, transmission, and output gears 132, 134, 136 of the drive mechanism 130 are journaled or otherwise rotatably coupled to the drive plate 140. Arrows indicating directions of rotation are provided to show relative directions of rotation of the various elements, i.e., if the drive gear 132 rotates clockwise, as shown in FIG. 4, then so too do the first output gear 136a, the second transmission gear 134b, and the ring gear 138—with the drive plate 140, while the second output gear 136b and first transmission gear 134a rotate counter-clockwise. Of course, if the direction of rotation of the drive gear 132 were reversed, all the other directions of rotation would also be reversed.

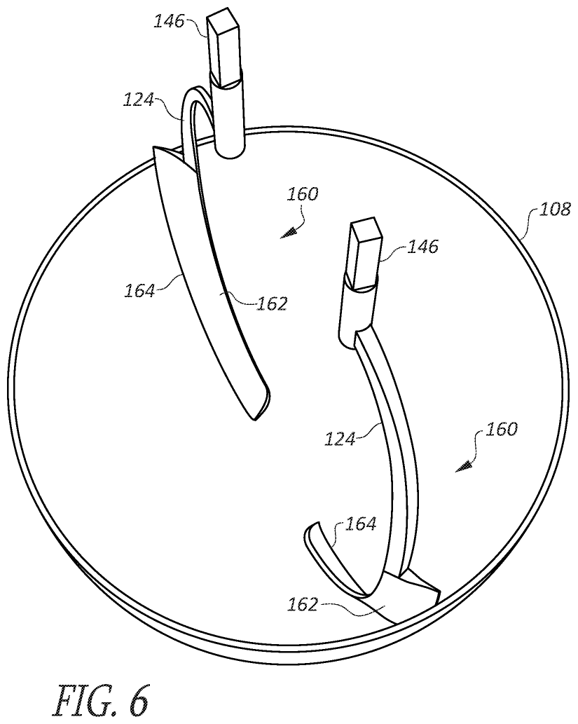

The mixing beaters 111 each include a coupler 142 configured to engage a corresponding beater socket 144 of a respective one of the output gears 136, so that the beaters rotate with the respective output gears. The handle 128 of the scraper 118 also includes a coupler 146 (see, also, FIG. 6) configured to engage a socket 148 that is fixed to the drive plate 140. With the coupler 146 of the scraper 118 engaging the socket 148 of the drive plate 140, the scraper is also fixed in position relative to the drive plate.

Because they are rotatably coupled to the drive plate 140, the transmission and output gears 134, 136 orbit with the drive plate about the central axis of rotation A_{R3}, even as they each rotate about their own respective axes of rotation. Thus, as the beaters 111 counter rotate relative to each other, they also rotate, or orbit, about the center of the mixing bowl 108. For its part, the scraper 118 orbits with the beaters 111 about the center of the mixing bowl 108. However, the scraper 118 does not also rotate with respect to the drive plate 140. As noted above, the scraper socket 148 is fixed to the drive plate 140. Thus, the scraper 118 is held so as to continually present a same aspect to the central axis of rotation A_{R3}. In other words, the scraper 118 rotates about its own axis once each time it orbits the central axis of rotation A_{R3}, so that its rotational period is equal to its orbital period. The term synchronous rotation will be used hereafter to describe this motion. During operation, with the scraper 118 in synchronous rotation about the central axis of rotation A_{R3}, the blade 120 remains in continuous contact with the inner surface of the bowl 108 as it rotates, moving material from the side of the bowl back into reach of the beaters.

The drive mechanism 130 is shown as one example, but embodiments are contemplated that include different types and configurations of drive mechanisms that are equivalent, and that perform the actions described above with reference to the drive mechanism 130. Furthermore, according to various embodiments, the mechanism shown is modified to meet specific design parameters. For example, relative sizes of the drive, transmission, output, and ring gears 132, 134, 136, 138 can be changed to obtain different relative rates of orbit and rotation, to provide appropriate orbit and rotation rates for mixers of different sizes and purposes, and having single or multiple beaters 111, single or multiple scrapers 118, etc. Design of the variations and alternatives to the drive mechanism 130 discussed above are within the abilities of a person having ordinary skill in the art, and so will not be described in detail.

In the embodiment shown, the output gears 136 are configured to counter-rotate. According to another embodiment, a drive mechanism is provided that is configured to rotate multiple beaters in a same direction—the beaters being sized and positioned such that they do not intermesh.

According to an embodiment, a stand mixer is provided that includes a cradle configured to rotate the bowl 108 during operation. The mixing element 110 includes one or more beaters 111 that are configured to rotate about respective axes of rotation, and a bowl scraper 118 is provided that is configured to conform to the shape of the bowl. However, neither the scraper 118 nor the mixing element 110 are configured to orbit about a common axis. Instead, the equivalent function is provided by rotation of the bowl 108 about its own central axis, which causes the positions of the mixing element 110 and the scraper 118 to orbit relative to the bowl, with the scraper cleaning the side of the bowl as the bowl rotates thereunder, substantially as previously described. Accordingly, claims that recite orbit of a scraper and/or one or more beaters relative to a bowl read also on embodiments in which the bowl rotates instead of, or in addition to the scraper(s) and beater(s).

The inventor has recognized a problem associated with typical stand mixers such as are known in the art: even with stand mixers in which beaters are configured to conform closely to the shape of the mixing bowl, there will usually be at least a small clearance between the blades or tines of a beater and the walls of the bowl, so that some of the material in the bowl will inevitably be deposited on the walls, and out of reach of the beaters. In mixers designed for use by consumers, this may not be a significant problem, as a small mixer can be easily stopped periodically to permit the user to scrape the side of the bowl. However, this is a bigger problem in large commercial and industrial mixers, inasmuch as it can take some time to start and completely stop such mixers, and time spent starting and stopping the mixer and scraping the side of the bowl increases production time and costs, and can also change the characteristics of the mixture. On the other hand, if the side is not scraped, some portion of the contents may not be fully mixed, which can change the ratio of ingredients in a mix, reduce the volume of the final mixture, increase waste of ingredients, and increase the per-unit cost of the final product. If a user is tempted to reduce down time by scraping the side without stopping the mixer, this can increase the likelihood of injury to the user and/or damage to the mixer. In contrast, in accordance with various embodiments, a user can operate a stand mixer with efficiency and economy without risking damage to the mixer or injury to the user.

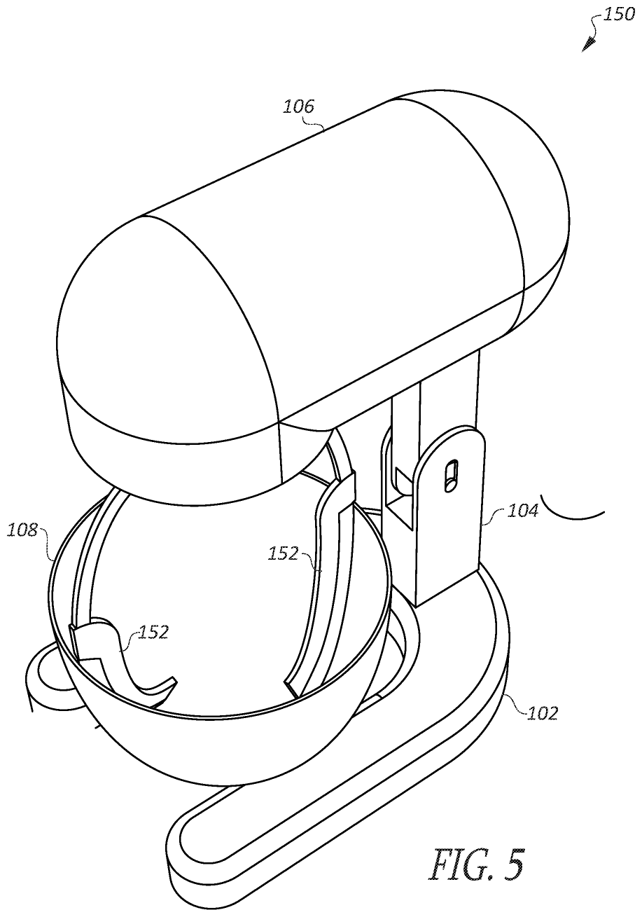

FIG. 5 is a perspective view of a stand mixer 150, according to an embodiment, that includes a pair of scrapers 152 positioned to clean opposite sides of the mixing bowl 108 as they orbit about the center of the bowl. The mixing element of the stand mixer 150 is omitted in the view of FIG. 5, in order to show additional details of the scrapers 152. These scrapers 152 differ from the scraper 118 of FIGS. 1-4 in that, while conforming to the side of the bowl 108, they also define slightly helical paths down the side of the bowl. Because of the helical shape of the scrapers 152, material removed from the side of the bowl 108 tends to move downward and inward, in the bowl 108. Of course, by reversing the direction of rotation, or configuring the scrapers 152 in the opposite direction, material in the bowl 108 can be made to move upward instead of downward.

FIG. 6 is a top perspective view of a bowl 108 and a pair of scrapers 160 of a stand mixer, according to an embodiment. The scrapers 160 are positioned in the bowl 108 as they would be held by their coupling with a compatible drive mechanism. In the embodiment shown, the scrapers 160 include respective blades 162 that are angled back from edges 164. Thus, as the scrapers 160 orbit within the bowl 108, material removed from the walls of the bowl tends to be lifted away from the surface of the bowl. For many types of mixtures of ingredients, this action can improve the efficiency of the stand mixer.

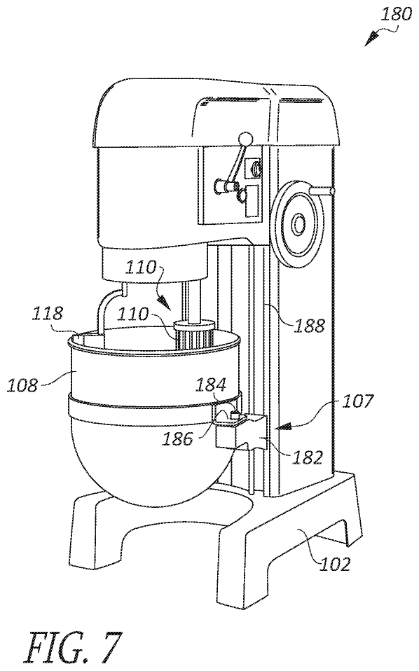

FIG. 7 is a perspective view of a stand mixer 180, according to an embodiment, that is configured for large batch mixing, such as might be used in commercial or industrial applications. The stand mixer 180 of FIG. 7 is configured to receive a single beater 111 and at least one scraper 118 that is configured substantially as described above with reference to other embodiments. In many cases, the bowls of large-capacity mixers, such as the mixer 180 of FIG. 7, are large enough and heavy enough, particularly while holding ingredients for mixing, that it is impractical or impossible to move them to and from a mixer by hand. Accordingly, the mixer 180 also includes a cradle 107 that comprises arms 182 with pins 184 that are received into sockets 186 coupled to the bowl 108. A powered lift mechanism is configured to raise and lower the cradle 107 on tracks 188. Thus, the bowl 108 can be moved on a conveyance, such as, e.g., a wheeled dolly, and positioned over the arms 182, which then lift the bowl into engagement with the mixing element 110 and scraper 118. In other respects, operation of the stand mixer 180 is similar to the operation described with reference to other embodiments, and, as in the other embodiments, the scraper 118 is configured to clean the inside walls of the bowl 108 during operation, enabling more continuous operation, thereby improving efficiency, safety and throughput.

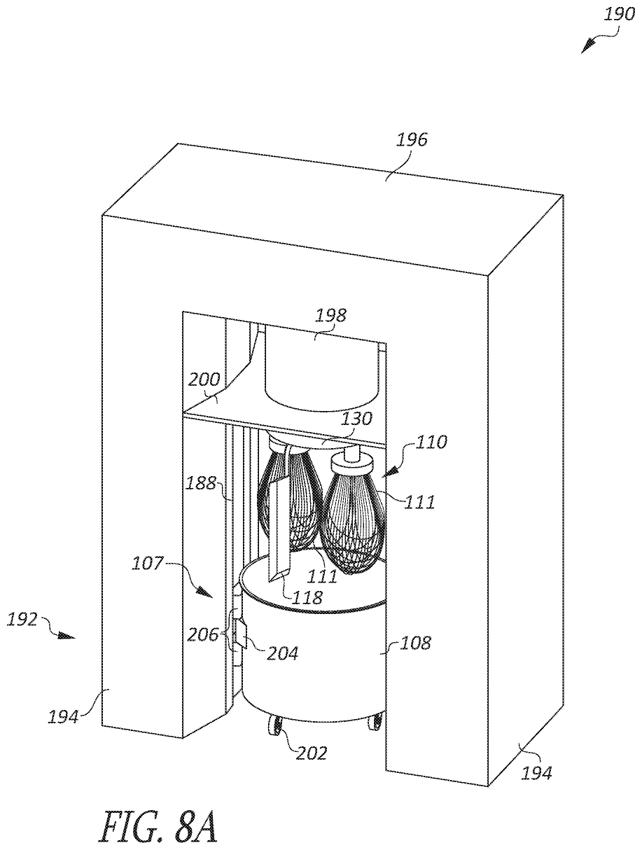

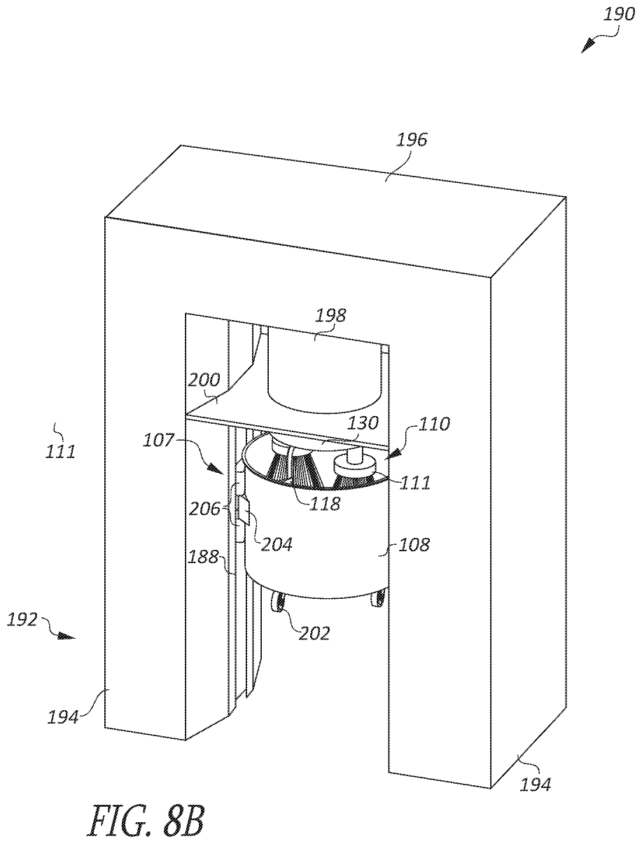

FIGS. 8A and 8B are perspective views of a stand mixer 190, according to another embodiment, that is configured for commercial or industrial applications. In FIG. 8A, the mixer 190 is shown in a standby configuration, while in FIG. 8B, the mixer is shown in an operational configuration. The mixer 190 includes a base 192 that comprises a pair of legs 194, joined by a headpiece 196. A motor housing 198 is fixed between the legs 194 below the headpiece 196 on a support plate 200, and a drive mechanism 130, configured receive a mixing element 110 and a bowl scraper 201, extends through the support plate. The mixing element 110 and the scraper 201 are coupled to the drive element 130 and are driven by the motor, as described with reference to previous embodiments. The bowl 108 has casters 202 which enable easy movement of the bowl, even while it is heavily loaded. The bowl also includes engagement brackets 204 configured to engage corresponding connectors 206 of the cradle 107. Each of the legs 192 includes a respective track 186 along which the connectors are configured to move, driven by a power lift mechanism.

In the embodiment shown, the bowl 108 has an approximately square profile, which is not well swept by the beaters 111, particularly the portion of the bowl where the side meet the bottom. Therefore, according to an embodiment, the scraper 201 is also shaped to scrape into the corner and across a portion of the bottom of the bowl 108, in order to prevent material from sticking to the bottom, outside the sweep of the beaters. According to another embodiment, the scraper is configured to scrape the side of the bowl, only.

In operation, a user rolls the bowl 108 into position between the legs 194, with the engagement brackets 204 engaging respective connectors 206, as shown in FIG. 8A. Ingredients to be mixed are introduced into the bowl 108 either before the bowl is moved into position or while the bowl is in position. The user couples beaters 111 and scraper 118 to the drive mechanism 130. The user then operates the power lift mechanism, raising the bowl 108 into engagement with the mixing element 110 and bowl scraper 118, and engages the motor. The motor drives the beaters 111 of the mixing element 110, via the drive mechanism 130, to rotate about respective axes of rotation, and drives the mixing element 110 and bowl scraper 118 to orbit about a third axis of rotation that is concentric with the bowl 108. Accordingly, the beaters 111 thoroughly mix the ingredients as the scraper 118 continually cleans portions of the mixture that adhere to the inside walls of the bowl during operation, moving them to within reach of the mixing element 110.

Upon completion of the mixing process, the motor is disengaged, and the user operates the power lift mechanism to lower the bowl 108 until the casters 202 again contact the floor. The bowl 108 can then be moved to another location or its contents accessed from its current position, as necessary.

Because of the operation of the bowl scraper 201, it is not necessary to pause operation of the mixer 190 to scrape down the side of the bowl 108. This can save considerable time and increase productivity, particularly in the operation of large mixers. The throughput of the mixer can be significantly greater than with conventional mixers, and in some case may permit the use of a smaller, lower capacity—and lower cost—mixer, or, in operations that employ multiple mixers, may reduce the number of mixers required, to meet a particular production requirement.

In the specification and claims, the term orbit is used to refer to rotation of an element about an axis that lies outside of that element. The term handle is used to refer to a portion of a scraper that extends between a coupler at one end and a scraper blade at the other end. The handle is not necessarily configured to be comfortably held in the hand of a user.

In many of the drawings, elements are designated with a reference number followed by a letter, e.g., 182a, or 182b. In such cases, the letter designation is used where it may be useful in the corresponding description to differentiate between or to refer to specific ones of a number of otherwise similar or identical elements. Where the description omits the letter from a reference, and refers to such elements by number only, this can be understood as a general reference to any or all of the elements identified by that reference number, unless other distinguishing language is used.

Ordinal numbers, e.g., first, second, third, etc., are used in the claims according to conventional claim practice, i.e., for the purpose of clearly distinguishing between claimed elements or features thereof, etc., without imposing further limitations on those elements. Ordinal numbers may be assigned arbitrarily, or assigned simply in the order in which elements are introduced. The use of such numbers does not suggest any other relationship, such as order of operation, relative position of such elements, etc. Furthermore, an ordinal number used to refer to an element in a claim should not be assumed to correlate to a number used in the specification to refer to an element of a disclosed embodiment on which that claim reads, nor to numbers used in unrelated claims to designate similar elements or features.

The abstract of the present disclosure is provided as a brief outline of some of the principles of the invention according to one embodiment, and is not intended as a complete or definitive description of any embodiment thereof, nor should it be relied upon to define terms used in the specification or claims. The abstract does not limit the scope of the claims.

Elements of the various embodiments described above can be omitted or combined to provide further embodiments. Aspects of the embodiments can be modified to employ concepts of known art to provide yet further embodiments.

These and other changes can be made to the embodiments in light of the above-detailed description. In general, in the following claims, the terms used should not be construed to limit the claims to the specific embodiments disclosed in the specification, but should be construed to include all possible embodiments along with the full scope of equivalents to which such claims are entitled. Accordingly, the claims are not limited by the disclosure.

1. A stand mixer, comprising:
a bowl cradle configured to hold a circular mixing bowl; and
a drive mechanism, including:
a first socket configured to rotate, and
a second socket,
the drive mechanism being configured to rotate the first socket and to orbit the first and second sockets relative to a bowl held by the bowl cradle, the drive mechanism further configured to hold the second socket such that the second socket rotates synchronously.

2. The stand mixer of claim 1, comprising:
a mixing bowl shaped and configured to be received by the bowl cradle; and
a scraper having:
a coupler configured to engage the second socket, and
a blade, including an edge shaped to conform to an inner surface of the mixing bowl.

3. The stand mixer of claim 2, wherein the drive mechanism is configured to orbit the first and second sockets relative to a bowl held by the bowl cradle by rotating the mixing bowl.

4. The stand mixer of claim 1, comprising a beater having a coupler configured to engage the first socket.

5. The stand mixer of claim 1, wherein:
the drive mechanism includes a third socket; and
the drive mechanism is configured to rotate the third socket and to orbit the third socket with the first and second sockets, relative to a bowl held by the bowl cradle.

6. The stand mixer of claim 1, wherein:
the drive mechanism includes a third socket; and
the drive mechanism is configured to orbit the third socket with the first and second sockets, relative to a bowl held by the bowl cradle, and further configured to hold the third socket such that the third socket rotates synchronously.

7. The stand mixer of claim 6, comprising:
a mixing bowl shaped and configured to be received by the bowl cradle; and
first and second scrapers, each having:
a coupler configured to engage a respective one of the second and third sockets, and
a blade, including an edge shaped to conform to an inner surface of the mixing bowl.

8. The stand mixer of claim 1, comprising a lift mechanism configured to raise and lower the cradle between a standby position, in which a bowl can be positioned in or removed from the cradle, and an operational position, in which a beater coupled to the first socket and a scraper coupled to the second socket are positioned inside a bowl held by the cradle.

9. A method for operating a stand mixer, comprising:
coupling a beater to a drive mechanism of a stand mixer;
coupling a scraper to the drive mechanism;
engaging a mixing bowl to a cradle of the stand mixer;
mixing a contents of the mixing bowl by rotating the beater while orbiting the beater relative to a central axis of the mixing bowl; and
scraping the side of the mixing bowl by orbiting the scraper relative to the central axis of the mixing bowl while synchronously rotating the scraper.

10. The method of claim 9, comprising:
coupling a second beater to a drive mechanism; and wherein
the mixing a contents of the mixing bowl includes rotating the second beater while orbiting the second beater relative to the central axis of the mixing bowl.

11. The method of claim 9, comprising:
coupling a second scraper to the drive mechanism; and wherein
the scraping the side of the mixing bowl includes orbiting the second scraper relative to the central axis of the mixing bowl while synchronously rotating the second scraper.

12. The method of claim 9, comprising:
raising the cradle and mixing bowl to a position in which the beater and the scraper are positioned inside the mixing bowl and the scraper is positioned with a blade edge of the scraper in contact with the side of the mixing bowl.

13. The method of claim 9, wherein:
the orbiting the beater and the orbiting the scraper relative to the central axis of the mixing bowl include rotating the mixing bowl about its central axis.
